(19) United States
(12) Patent Application Publication
(10) Pub. No.: US 2010/0235372 A1
(43) Pub. Date: Sep. 16, 2010

(54) DATA PROCESSING APPARATUS AND METHOD OF PROCESSING DATA

(76) Inventors: Peter Thomas Camble, Bristol (GB); Gregory Trezise, Somerset (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/671,346

(22) PCT Filed: Oct. 25, 2007
(86) PCT No.: PCT/US07/22586

§ 371 Date: Jan. 29, 2010

(51) Int. Cl. G06F 17/30

(52) U.S. Cl. 707/758; 707/802; 707/E17.044; 707/E17.014

(57) ABSTRACT

Data processing apparatus comprising: a chunk store containing specimen data chunks 6, a manifest store containing at least one manifest that represents at least a part of a data set and is divided into manifest segments, each comprising at least one reference to at least one of said specimen data chunks, the data processing apparatus being operable to: process input data into input data segments, each comprising one or more input data chunks: and identify at least one of said manifest segments having at least one said reference to a said specimen data chunk corresponding to an input data chunk of at least one of the input data segments.

### BACKGROUND OF THE INVENTION

Data held on a primary data storage medium may be backed-up to secondary data storage medium. The secondary data storage medium may be in a different location to the primary data storage medium. Should there be at least a partial loss of the data on the primary data storage medium, data may be recovered from the secondary data storage medium. The secondary data storage medium may contain a history of the data stored on the primary data storage medium over a period of time. On request by a user, the secondary data storage medium may provide the user with the data that was stored on the primary data storage medium at a specified point in time.

Data back-up procedures may be carried out weekly, daily, hourly, or at other intervals. Data may be backed-up incrementally, where only the changes made to the data on the primary data medium since the last back-up are transferred to the secondary data storage medium. A full back-up may also be performed, where the entire contents of the primary data medium are copied to the secondary data medium. Many other back-up strategies exist.

When backing-up data, a particular part of the data being backed-up may have previously been stored to the primary data storage medium, which may especially be the case when full back-ups are carried out. Storing the same data numerous times represents an inefficient use of a data storage medium.

### SUMMARY OF THE INVENTION

One embodiment of the present invention provides data processing apparatus comprising: a chunk store containing specimen data chunks, a manifest store containing at least one manifest that represents at least a part of a data set and is divided into manifest segments, each comprising at least one reference to at least one of said specimen data chunks, the data processing apparatus being operable to: process input data into input data segments, each comprising one or more input data chunks: and identify at least one of said manifest segments having at least one said reference to a said specimen data chunk corresponding to an input data chunk of at least one of the input data segments.

In one embodiment, the data processing apparatus is operable to select a said input data segment and identify at least one of said manifest segments having at least one said reference to a said specimen data chunk corresponding to an input data chunk of the selected input data segment.

In one embodiment, the data processing apparatus is operable to identify from the at least one identified manifest segment at least one said reference to a said specimen data chunk corresponding to at least one further input data chunk of at least one input data segment.

In one embodiment, the data processing apparatus is operable to prioritise a plurality of identified manifest segments for at least one subsequent operation.

In one embodiment, the plurality of identified manifest segments are prioritised according to the number of said references each has, to specimen data chunks corresponding to an input data chunk of at least one of the input data segments.

In one embodiment, the plurality of identified manifest segments are prioritised in descending order of the number of said references each contains, to specimen data chunks corresponding to an input data chunk of at least one of the input data segments.

In one embodiment the data processing apparatus is operable to identify said manifest segments from different manifests stored in the manifest store.

In one embodiment, the input data segments and said manifest segments are each of a predetermined size.

In one embodiment, the input data segments and manifest segments are substantially identical in size.

In one embodiment, the data processing apparatus is operable to compare each input data chunk of a given input data segment with the specimen data chunks referenced in the identified at least one manifest segments, to identify specimen data chunks corresponding to input data chunks of said input data segment.

In one embodiment, the data processing apparatus is operable to process each input data segment in a predetermined order.

In one embodiment, the data processing apparatus comprises a chunk index containing information relating to said specimen data chunks.

In one embodiment, the data processing apparatus is operable to identify at least one of said manifest segments using said information in the chunk index.

In one embodiment, the manifest store contains a chunk identifier of said at least one specimen data chunk referenced by said at least one manifest.

In one embodiment the data processing apparatus is operable to generate a chunk identifier of each input data chunk for a said input data segment and compare the chunk identifier of each input data chunk with the chunk identifier contained in the manifest store.

In another embodiment of the invention, there is provided a data processor comprising: a chunk store containing specimen data chunks, a manifest store containing at least one manifest that represents at least a part of a data set and is divided into manifest segments, each comprising at least one reference to at least one of said specimen data chunks, the processor being operable to: process input data into input data segments, each comprising one or more input data chunks; select an input data segment; and identify at least one of said manifest segments having at least one said reference to a said specimen data chunk corresponding to an input data chunk of the selected input data segment.

In another embodiment of the invention, there is provided a method of processing data, using: a chunk store containing specimen data chunks, a manifest store containing at least one manifest that represents at least a part of a data set and is divided into manifest segments, each comprising at least one reference to at least one of said specimen data chunks, the method comprising: processing input data into input data segments, each comprising one or more input data chunks; selecting an input data segment; and identifying at least one of said manifest segments having at least one said reference to a said specimen data chunk corresponding to an input data chunk of the selected input data segment.

In one embodiment, the method comprises analysing said identified at least one manifest segment to identify at least one said reference to a said specimen data chunk corresponding to at least one further input data chunk of the selected input data segment.

In one embodiment, the identified at least one manifest segments are prioritised according to the number of references each contains, to specimen data chunks corresponding to input data chunks of the selected input data segment.

In another embodiment there is provided a method of compiling a manifest, representative of an input data set, the method comprising: processing the input data set into input data segments, each comprising one or more input data chunks.

identifying, in a manifest store, at least one manifest segment of at least one previously compiled and stored manifest, having a reference to at least one specimen data chunk, stored in a chunk store, corresponding to an input data chunk of at least one of the input data segments.

### BRIEF DESCRIPTION OF THE DRAWINGS

Embodiments of the invention will now be described, by way of example only, with reference to the accompanying drawings, in which:

FIG. 1 shows a schematic representation of a data set;

FIG. 2 shows a schematic representation of a data processing apparatus according to an embodiment;

FIG. 3 shows a schematic representation of the data processing apparatus of FIG. 2, in use;

FIG. 4 shows a schematic representation of another data set;

FIG. 5 shows a schematic representation of another data processing apparatus according to another embodiment;

FIG. 6 shows a flow chart of a method according to an embodiment of the present invention.

### DETAILED DESCRIPTION

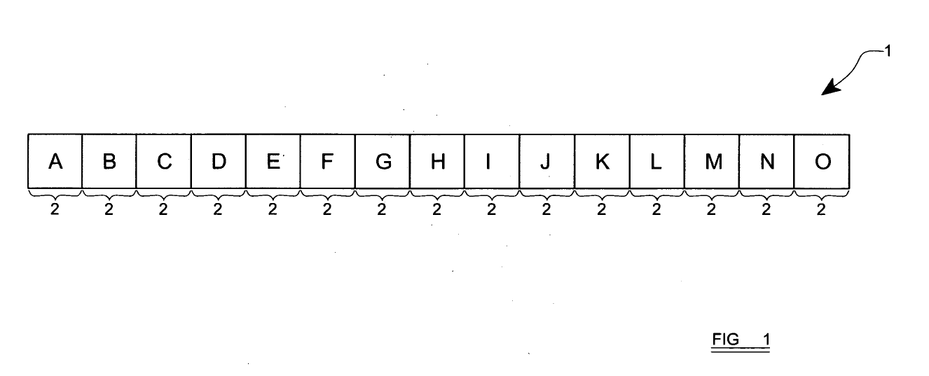

FIG. 1 shows a schematic representation of a data set 1. A data set 1 may be shorter or longer than that shown in FIG. 1. A data set 1 comprises an amount of data, which may be in the order or 10 bytes, 1000 bytes, or many millions of bytes. A data set may represent all the data for a given back-up operation, or at least a part of a larger data set.

A back-up data set may comprise a continuous data stream or a discontinuous data stream. Whichever, the data set may contain many distinct, individual files or parts of files. The data set may not be partitioned into the individual files it contains. The data set may contain embedded information, comprising references to the boundaries of the individual files contained in the data set. The data set may then more easily be dissected into its constituent components. The size of the embedded information may represent a significant portion of the total data. Backing-up data with embedded file information increases the required capacity of the data storage medium.

Data processing apparatus according to an embodiment is operable to process an input data set into one or more input data chunks. An input data set may be divided into a plurality of input data chunks. Each input data chunk may represent an individual file, a part of an individual file, or a group of individual files within the input data set. The data set may be processed into input data chunks based on properties of the input data as a whole, with little or no regard to the individual files contained therein. The boundaries of data chunks may or may not be coterminous with file boundaries. The data chunks may be identical or varying in size.

FIG. 1 illustrates a schematic representation of an input data set 1 processed into data chunks 2. For convenience, each input data chunk is labelled in FIG. 1 from A-O, identifying that the data chunks 2 are distinct from one another. The input data set 1 may be divided into more input data chunks 2 than those shown in FIG. 1. An input data set 1 may be many terabytes in size, and be processed into billions of input data chunks. There are specific schemes available to the skilled person to determine how the input data set 1 is processed into input data chunks 2 and which information each input data chunk 2 contains.

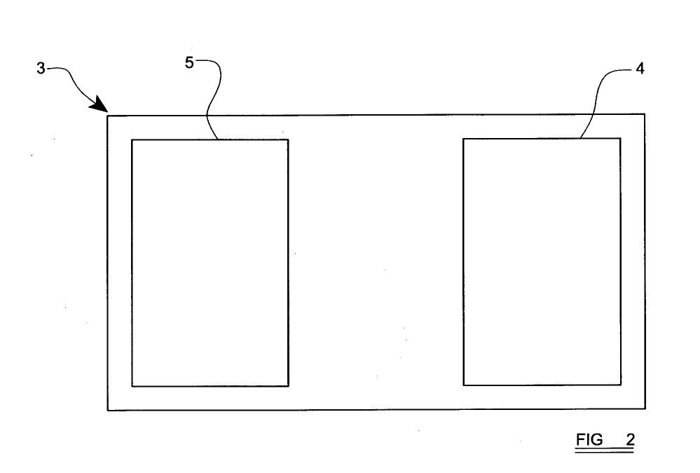

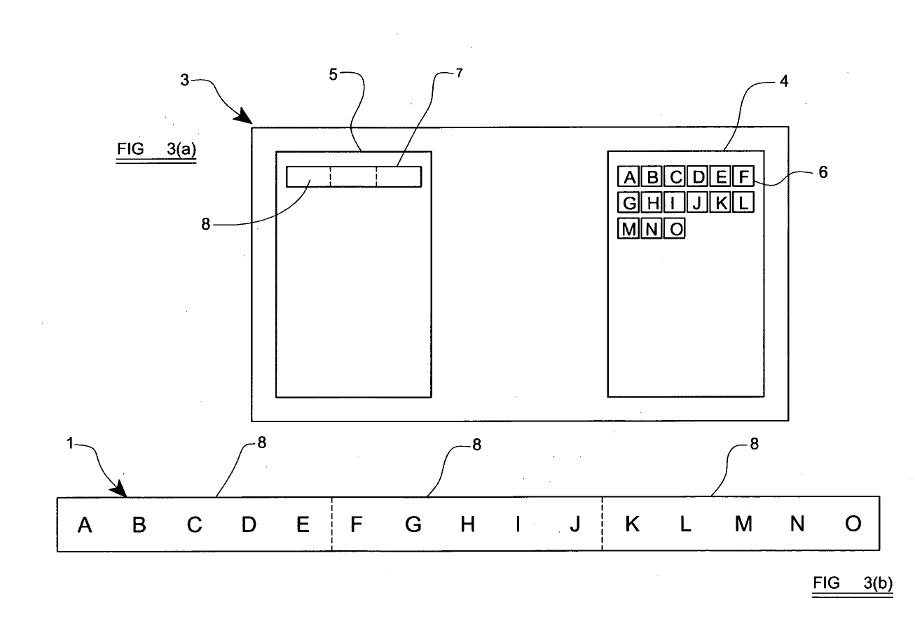

FIG. 2 shows data processing apparatus 3 (including at least one processor) according to an embodiment. The data processing apparatus 3 comprises a chunk store 4 and a manifest store 5. The manifest store 5 may be discrete from, and separate to, the chunk store 4 but both stores 4, 5 may reside on a common data storage medium or memory device. As an input data set 1 is processed by data processing apparatus 3, the input data chunks 2 are stored to the chunk store 4 as specimen data chunks 6, as shown in FIG. 3(a). A specimen data chunk 6 is a carbon copy of an input data chunk 2. The chunk store 4 may store a plurality of specimen data chunks 6. The chunk store 4 may contain all the input data chunks 2 that have been previously processed by the data processing apparatus 3. FIG. 3(a) shows the data processing apparatus being populated with data for the first time.

In one embodiment, both the chunk store 4 and manifest store 5 are stored in non-volatile storage.

As an input data chunk 2 is added to the chunk store 4 as a specimen data chunk 6, a manifest 7 is compiled, as also shown in FIG. 3(a). A manifest 7 is a representation of a data set 1. The manifest 7 comprises references to specimen data chunks 6 in the chunk store 4 which correspond to the input data chunks 2 comprising the input data set 1. So, the references of the manifest 7 may be seen as metadata to specimen data chunks 6. If the references to specimen data chunks 6 of a given manifest 7 are smaller in size than the specimen data chunks 6 referred to by the manifest 7, then it will be appreciated that a manifest 7 may be smaller in size than the input data set 1 it represents. A manifest may be seen as a copy of the input data set which it represents, wherein input data chunks of the input data have been ‘replaced’ with a reference to a specimen data chunk which corresponds to the input data chunks. Thus, a manifest may begin as a carbon copy of the input data set, having the same size; and the data size of the manifest is reduced as some input data chunks are replaced by references to specimen data chunks corresponding to the input data chunks.

When an input data set 1 has been processed into input data chunks 2 and a manifest 7 compiled, representing the input data set 1, the manifest 7 is stored in the manifest store 5, as shown schematically in FIG. 3.

If a user of data processing apparatus 3 wishes to recover the data of a given input data set 1—which may relate to a back-up made at a particular point in time—the data processing apparatus will retrieve the corresponding manifest 7 from the manifest store 5. Each reference in the manifest 7 to specimen data chunks 6 in the chunk store 4 is then used to reconstruct the original data set 1.

The data processing apparatus is operable to divide a manifest 7 into manifest segments 8. A manifest segment 8, shown schematically in FIG. 3(b), may be a section of concurrent data of the manifest 7. A manifest 7 may be divided into a plurality of manifest segments 8. All the manifest segments 8 of a manifest 7 may each be of a predetermined size, varying size, or may all be substantially the same size. In one embodiment, each manifest segment 8 comprises a plurality of references to specimen data chunks 6 in the chunk store 4.

In one embodiment, a manifest 7 is stored in the manifest store 5 as a single block of references to specimen data chunks 6. The manifest segments 8 may be partitioned within the manifest 7 by the use of markers or reference points to boundaries. The boundary of a manifest segment 8 may or may not be coterminous with a boundary of a reference to a specimen data chunk 6.

Manifest segments 8 may be stored separately in the manifest store. There may be a record maintained of which manifest segments 8 together constitute a particular manifest 7. If a user wishes to recover a data set represented by a given manifest 7 divided into manifest segments 8, the manifest 7 may first be reconstructed using the manifest segments 8 and the record of how the manifest segments together constitute the manifest. Each reference in the reconstructed manifest 7 to specimen data chunks 6 in the chunk store 4 is then used to reconstruct the original data set; or, rather, each reference in the each manifest segment 8 of the reconstructed manifest 7 is then used to reconstruct the original data set.

In the example shown in FIGS. 3(a) and (b), the input data set 1 has been represented by manifest 7 with three manifest segments 8. The manifest segments each contain five references to specimen data chunks 6 stored in the chunk store 4. The three manifest segments are: ABCDE, FGHIJ and KLMNO. It should be appreciated that a manifest segment 8 may contain more or fewer references than shown in this example. Each manifest segment 8 may contain many thousands of references to specimen data chunks 6.

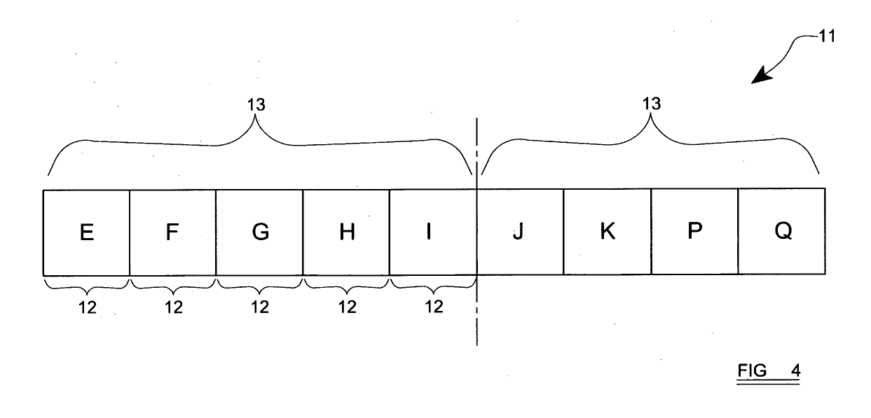

A schematic representation of a second input data set 11 to be processed is illustrated in FIG. 4. Without data processing apparatus 3, the second input data set 11 may be stored in its entirety. Thus, even though the reader will recognise that both input data sets 1, 11 comprise the common input data chunks E to K, both occurrences of each would be stored, which is an inefficient use of a data storage medium.

With data processing apparatus 3, when the input data set 11 is presented to the data processing apparatus 3, the input data set 11 is processed into input data chunks 12. Further, the input data set 11 is processed into input data segments 13. Each input data segment may comprise one or more input data chunks. In one embodiment, an input data set 11 may first be processed or divided into input data segments 13, with each input data segment 13 being divided into input data chunks 12 thereafter. In another embodiment, input data segments 13 may be created based on the number of input data chunks into which the data set 11 has been processed.

The input data segments 13 may contain as many input data chunks 12 as a manifest segment 8 comprises references to specimen data chunks 6. In the example shown in FIG. 4, the first input data segment 13 contains five input data chunks 12, whereas the second input data segment contains four input data chunks 12. In another embodiment, the input data segments 13 may contain more or fewer input data chunks 12. In one embodiment, input data sets 11 may be divided into input data segments 13 containing up to a predetermined maximum number of input data chunks 12.

A data processing apparatus 3 is operable to identify at least one manifest segment 8 in the manifest store 5 that includes at least one reference to a specimen data chunk 6 corresponding to at least one of the input data chunks 12 of at least one of the input data segments 13 of the input data set 11. When processing the input data set 11 illustrated in FIG. 4, data processing apparatus 3 may identify that at least one of the manifest segments 8 stored in the manifest store 5 includes a reference to at least one specimen data chunk 6 corresponding to at least one of the input data chunks 12 in the input data segments 13. In this example, the data processing apparatus may identify that, between them, the manifest segments 8 include references to specimen data chunks E,F,G,H,I,J and K. After so identifying, the data processing apparatus 3 will not store the input data chunks E,F,G,H,I,J and K again in the chunk store 4, because they already exist therein as specimen data chunks 6. Instead, the manifest to be compiled for the input data set 11 will comprise references to specimen data chunks E,F,G,H,I,J and K already in the chunk store 4.

There are various methods available to the skilled person to identify a manifest segment in the manifest store which includes at least one reference to a specimen data chunk. In one embodiment, a chunk identifier may be generated for each input data chunk in an input data set. Chunk identifiers may be hashes of chunk and are described later. The chunk identifier of an input data chunk may be compared with the chunk identifiers of the specimen data chunks already in the chunk store. If a matching specimen data chunk is found, any manifests which contain a reference to that specimen data chunk may be identified.

In another embodiment, a byte-by-byte comparison may be carried out between an input data chunk and the specimen data chunks in the chunk store. Embodiments of the present invention may use other methods of identifying specimen data chunks in the chunk store which correspond to an input data chunk and are not limited to the above described examples.

The manifest segments of the manifest to be compiled for input data set 11 may comprise as many references to specimen data chunks 6 as the input segments 13 of the input data 11 comprise input data chunks 12. Thus, a manifest segment 8 and its corresponding input data segment 13 may mirror one another.

It will be noted by the reader that the chunk store 4 does not contain specimen data chunks 6 corresponding to input data chunks P and Q. Similarly, the manifest 7 in the manifest store 5 does not contain references to specimen data chunks 6 corresponding to input data chunks Q and P. In one embodiment, the data processing apparatus is operable to determine that the chunk store 4 does not already contain specimen data chunks 6 corresponding to input data chunks Q and P.

Accordingly, data processing apparatus 3 may store the input data chunks Q and P as specimen data chunks 6 in the chunk store 4. The manifest for the input data set 12 is then completed by adding references to specimen data chunks Q and P. The new manifest is then added to the manifest store 5. As described above, the manifest is divided into manifest segments. In this example, the first manifest segment may contain references to specimen data chunks EFGHI and the second manifest segment may contain references to specimen data chunks JKPQ.

In one embodiment, after the data processing apparatus 3 has part compiled a manifest with references to specimen data chunks EFGHIJK, the data processing apparatus 3 is operable to select one of input data chunks P and Q, and to attempt to identify at least one manifest segment 8 in the manifest store 5 that includes at least one reference to a specimen data chunk 6 corresponding to either one of input data chunks P and Q. In the example illustrated, no such manifest segments will be located. Data processing apparatus 3 may be operable to identify manifest segments 8 including references to specimen data chunks corresponding to each input data chunk 2 of an input data set 1, or of an input data segment of an input data set.

As a result of using data processing apparatus, the chunk store 4 may contain only one occurrence of each specimen data chunk 6, which is an efficient use of the chunk store 4. The ‘footprint’ of storing the first 1 and second 11 input data sets using data processing apparatus may be smaller than the footprint of storing the first 1 and second 11 input data sets without using a processor according to an embodiment.

With data processing apparatus 3, the data processing apparatus 3 processes the input data set 11 into input data segments 13, each containing input data chunks 12. The data processing apparatus may be operable to select an input data segment 13 from the input data set 11. The selection may be the first input data segment 11 in the input data set 11, or it may be another selection. The selection of an input data segment 13 for processing from the divided input data set 11 may be random or pseudo-random.

In one embodiment, the data processing apparatus 3 uses the selected input data segment 13 to identify at least one manifest segment 8 already stored in the manifest store 5 which includes at least one reference to a specimen data chunk 6 corresponding to at least one input data chunk 12 of the selected input data segment 13.

Having identified at least one manifest segment 8 in the manifest store 5, as above, the data processing apparatus 3 embodying the present invention is operable to analyse the at least one manifest segment 8 to identify specimen data chunks 6 corresponding to at least one further input data chunk 12 of the selected input data segment 13.

A benefit of data processing apparatus 3 is that an exhaustive search of the chunk store 4 for each and every input data chunk 2, to determine whether it has already been stored as a specimen data chunk 6, is not required. Instead, data processing apparatus 3 may utilise the manifest segments 8 created for previously processed and stored data sets. The benefits of data processing apparatus 3 are further demonstrated when the input data sets being processed are similar, to a large extent, to previously processed data sets. For example, between two full back-up operations, only a small portion of the respective data sets may be different. To have to methodically search through each specimen data chunk 6 stored in the chunk store 4, to find specimen data chunks 6 corresponding to each input data chunk of an input data segment, is inefficient and time consuming.

Data processing apparatus 3 is able to exploit the fact that each input data set 1 being processed may be similar. As such, previous similar manifest portions can be used to compile at least a part of a new manifest for the latest input data set, since many of the specimen data chunks 6 references by a previous manifest segment may be identical to input data chunks of an input data segment of the input data set being processed.

In one embodiment, having identified said at least one manifest segment, the data processing apparatus 3 is operable to search within that manifest segment for all other references to specimen data chunks 6 in the chunk store 4, to identify specimen data chunks 6 corresponding to further input data chunks 2 of the input data segment being processed. In one embodiment, the search is performed by selecting an input data chunk from a selected input data segment, and comparing it with each reference in the at least one identified manifest segment. When a reference to a specimen data chunk 6 corresponding to an input data chunk is found, that input data chunk is represented in a new manifest with a reference to the specimen data chunk 6. Subsequent input data chunks 2 of the input data segment being processed are then selected for subsequent searches. The search operation may continue until all input data chunks 2 of an input data segment have been compared with all references in the identified manifest segment(s).

In another embodiment, the search operation may be terminated when a predetermined number of references to specimen data chunks 6 corresponding to input data chunks 2 of an input data segment have been found. In another embodiment, the search operation may be terminated when the data processing apparatus 3 has failed to find references to specimen data chunks 6 corresponding to a predetermined number of input data chunks 2 in the input data segment. A benefit of this embodiment is that manifest segments which do not contain references to specimen data chunks 6 corresponding to any other input data chunks 2 of an input data segment may quickly be discounted from the search procedure.

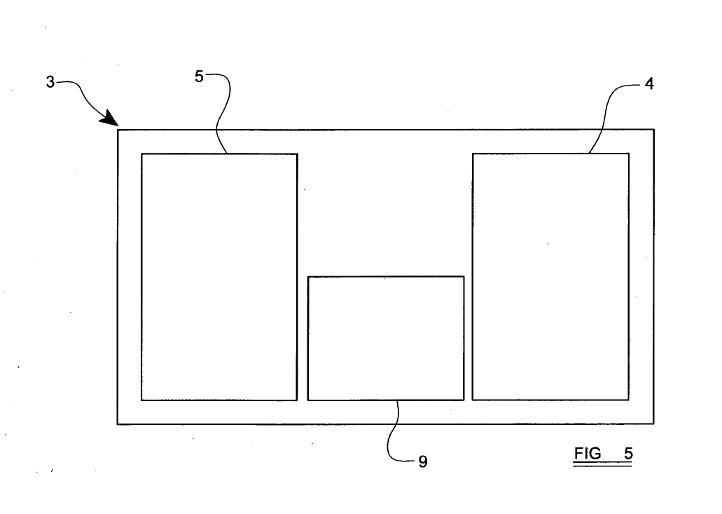

In one embodiment, the data processing apparatus 3 further provides a chunk index 9, as shown in FIG. 5. The chunk index 9 contains information on at least one of the specimen data chunks 6 stored in the chunk store 4. In one embodiment, the chunk index 9 contains information relating only to some specimen data chunks 6 contained in the chunk store 4. The specimen data chunks 6 on which the chunk index 9 contains information may be specifically selected or randomly chosen. In another embodiment, the chunk index 9 may contain information on every specimen data chunk 6 stored in the chunk store 4.

In one embodiment, the chunk index 9 may be stored in random access memory (RAM). The memory may be volatile.

In an embodiment of the present invention, the information contained in the chunk index 9 for a given specimen data chunk 6 may include a chunk identifier of the specimen data chunk. A chunk identifier may be a digital fingerprint of the specimen data chunk 6 to which it relates. The chunk identifier may be a unique chunk identifier, being unique for a particular specimen data chunk 6. The algorithm for generating chunk identifiers may be selected so as to be capable of generating unique chunk identifiers for a predetermined number of specimen data chunks 6. In one embodiment, the chunk identifier is generated using the SHA1 hashing algorithm. Other hashing algorithms may be used, such as SHA2 or MD5. In one embodiment, the hashing algorithm is selected and configured such that it is substantially probabilistically unlikely that two specimen data chunks 6 would produce an identical chunk identifier.

In another embodiment, the information contained in the chunk index 9 for a given specimen data chunk 6 may include only a partial chunk identifier. For example, although the specimen data chunk 6 may have a unique chunk identifier, only a portion of the chunk identifier may be stored against the record for the specimen data chunk 6 in the chunk index 9. In one embodiment, the partial chunk identifier may comprise the first predetermined number of bits of the full chunk identifier. For example, if a full chunk identifier for a given specimen data chunk 6 comprises 20 bits (such as that produced by the SHA1 algorithm), the chunk index 9 may store, for example, 15 bits of the chunk identifier. The predetermined bits may be the most significant bits (MSB) of the chunk identifier, the least significant bits (LSBs) or intermediate bits of the full chunk identifier. In one embodiment, the chunk identifiers generated are substantially pseudorandom, thereby having a substantially statistically uniform distribution of values.

It follows, therefore, that the partial identifiers of two different specimen data chunks 6 may be identical, even though their respective full chunk identifiers are different to one another; and unique. A benefit of storing only a partial chunk identifier in the chunk index 9 is that the size of the chunk index 9 is reduced.

In one embodiment, for a particular entry in the chunk index 9, relating to a given specimen data chunk 6, there are stored details of at least one manifest segment 8 (and/or manifest 7) in the manifest store 5 which includes a reference to said specimen data chunk 6. In one embodiment, there is stored in the index a list of all manifest segments which contain at least a reference to that specimen data chunk 6. In another embodiment, there may be stored only a partial list of the manifest segments 8 which contain at least one reference to that specimen data chunk 6.

In one embodiment, for a given entry in the chunk index 9 relating to a specimen data chunk, there is stored a reference to at least one manifest segment 8 in the manifest store which includes a reference to that specimen data chunk. In one embodiment, the reference may be to the manifest segment generally. In another embodiment, the reference may indicate the location within the manifest segment where there is a reference to the specimen data chunk.

In use, the manifest store 5 may contain many manifest segments 8, each forming part of a manifest 7 representing a previously processed data set 1. In one embodiment, the manifest store 5 contains information relating to each manifest segment 8 contained therein. The information may include the properties associated with each manifest segment 8; such as its size, the number of references it contains or the name and other details of the data set which it represents. The information for a particular manifest segment may include a chunk identifier of at least one of the specimen data chunks 6 referenced by the manifest segment 8. Thus, a particular manifest segment 8 may not only include a set of references to specimen data chunks 6 stored in the chunk store 4, but a full chunk identifier for each of those specimen data chunks 6 referenced.

In one embodiment, having identified at least one manifest segment 8 in the manifest store that includes at least one said reference to a said specimen data chunk corresponding to at least one input data chunk of a given input data segment, the data processing apparatus is operable to analyse the identified manifest segment to identify specimen data chunks corresponding to further input data chunks of the input data segment. In the embodiment where the manifest segment comprises a chunk identifier of each specimen data chunk referenced by the manifest segment, data processing apparatus is operable to compare the chunk identifier of input data chunks with the chunk identifiers in the manifest segment. The benefit of this is that no access to the information in the chunk index 9 may be required. Accordingly, performing a comparison procedure using the identified manifest segment, and not the chunk store 4, may allow for at least apart of the data for comparison to be processed whilst in RAM.

The manifest information may comprise the location of at least one of the specimen data chunks 6 in the chunk store 4, referenced by a manifest segment 8. The data set represented by a manifest may thus be reconstructed using only the location data in the manifest and the chunk store 4. No access to the chunk index 8 may be required.

Data processing apparatus 3 is operable to generate a chunk identifier of an input data chunk 2. In one embodiment, the data processing apparatus 3 is operable to generate a chunk identifier for each input data chunk 2 after, or at the same time as, the input data set 1 has been/is processed into input data chunks 2 and/or input data segments.

The chunk identifier generated for an input data chunk 2 may be used to identify a specimen data chunk 6 in the chunk store 4 corresponding to the input data chunk 2. In one embodiment, the chunk identifier of the input data chunk 2 is compared with the chunk identifier of a specimen data chunk 6. A benefit of this is that the input data chunk 2, itself, is not directly compared with a specimen data chunk 6. Since the respective chunk identifiers may be smaller in size than the input/specimen data chunks 6 they represent, the comparison step, to see if the two chunk identifiers correspond to one another, may be performed more quickly. Moreover, since the chunk identifiers may be relatively smaller in size than the respective chunks to which they relate, the comparison step may be performed whilst both chunk identifiers are stored in RAM. If the chunk identifier of an input data chunk 2 is identical to the chunk identifier of a specimen data chunk, then input data chunk 2 and specimen data chunk can be assumed to be identical to one another. This assumes, as noted above, that the algorithm for generating chunk identifiers is chosen so as to generate unique identifiers. The use of partial chunk identifiers will produce a non-unique set of identifiers meaning that one or more potential corresponding specimen data chunks will be identified.

In one embodiment, the processing apparatus is operable to compare the chunk identifier of an input data chunk 2 with the chunk identifiers stored in the chunk index 9. The comparison step may be performed by comparing the chunk identifier of an input data chunk 2 with each chunk identifier stored in the chunk index 9, in turn. Alternatively, the chunk identifiers in the chunk index 9 may be organised based on properties of the chunk identifiers. For example, the chunk identifiers in the chunk index 9 may be arranged in a tree configuration, based on the binary state of each bit of the chunk identifiers. In this example, the MSB of each chunk identifier may be analysed, and each chunk identifier allocated to a branch of the tree depending on the value of the MSB, i.e. either ‘0’ or ‘1’. Each of the two ‘branches’ may further bifurcate based on the value of the next MSB. Each of those branches will bifurcate further, based on the following MSB, and so on.

With the above described configuration of the entries in the chunk index 9, the data processing apparatus 3, in attempting to find an entry in the chunk index 9 for a specimen data chunk 6 corresponding to a selected input data chunk 2, is operable to quickly ‘drill down’ the entries in the chunk index 9.

In some embodiments, by ‘corresponding’ is meant that the chunk identifier of an input data chunk 2 is identical to the chunk identifier of a specimen data chunk 6. The input data chunk 2 and specimen data chunk 6 are therefore said to be ‘corresponding’ to one another. Alternatively, where partial chunk identifiers are used, although the respective partial chunk identifiers for a given input data chunk 2 and specimen data chunk 6 may be identical, the actual input data chunk 2 and specimen data chunks 6 may not be identical, as described above. Nevertheless, the input data chunk 2 and specimen data chunk 6 are said to be corresponding, since at least their respective partial chunk identifiers are identical to one another.

In one embodiment of the present invention, after generating a chunk identifier for an input data chunk 2, and identifying a corresponding chunk identifier in the chunk index 9 relating to a specimen data chunk 6 stored in the chunk index 9, data processing apparatus 3 is operable to perform a verification procedure. The verification procedure comprises comparing the input data chunk 2 with the identified specimen data chunk 6 stored in the chunk store 4, to confirm whether the two data chunks are, in fact, identical. Without the verification procedure, and especially where partial chunk identifiers are used, it may be that a specimen data chunk 6 identified as ‘corresponding’ is not actually identical to the input data chunk 2. To include a reference to the non-identical specimen data chunk 6 will introduce an error in the manifest, and prevent accurate restoration of data represented in the manifests.

In the embodiment where partial chunk identifiers are used, a processor according to an embodiment may identify more than one ‘corresponding’ specimen data chunk 6, for the reasons described above. Of course, the input data chunk 2 may only be identical to one of the specimen data chunks 6 stored in the chunk store 4. Accordingly, should more than one ‘corresponding’ specimen data chunk 6 be identified, the verification procedure allows for the data processing apparatus 3 to identify which of the more than one specimen data chunks 6 is truly identical to the input data chunk 2. Although when storing only partial chunk identifiers, the verification step necessarily constitutes a further step, there is still a benefit in that the chunk index 9 may be smaller in size, since it does not store full chunk identifiers. The reduction in the size of chunk index 9 needed may outweigh the disadvantages, if any, of performing the verification procedure.

In another embodiment, the verification procedure may be performed by comparing the chunk identifier of an input data chunk with a chunk identifier contained in an identified manifest segment. A benefit of this is that no access to chunk store may be required at all. The verification procedure may be performed using solely the information contained in the manifest segment and the chunk identifiers produced for the input data chunks. Where partial chunk identifiers are stored in the chunk index, there may exist the situation where the partial chunk identifier of an input data chunk matches the partial chunk identifier of a specimen data chunk, even though the respective input/specimen data chunks do not match one another. As a consequence, the at least one manifest segment identified as containing a reference to a specimen data chunk corresponding to an input data chunk may, not, in fact reference specimen data chunks corresponding to any input data chunks. In one embodiment, the data processing apparatus is operable to perform a verification procedure on the identified manifest segments(s). In one embodiment, when the at least one manifest segment has been identified, the chunk identifier stored in the manifest segment(s) of the specimen data chunk which was indicated as corresponding to an input data chunk is verified. Only if the chunk identifier is identical to the chunk identifier of the input data chunk may the manifest segment be used for subsequent operation. This embodiment may achieve the same effect as performing the verification procedure (which refers to the chunk index), but has the advantage that is does not need to refer to the chunk index. It will be appreciated that the returned manifest segment may be much smaller in size than the chunk store. Accordingly, performing a comparison procedure using the identified manifest segment, and not the chunk store 4, may allow for at least a part of the data for comparison to be processed whilst in RAM.

As described above, the chunk index 9 of one embodiment contains information relating only to some specimen data chunks 6 in the chunk store 4. Thus, the chunk index 9 may be said to be a ‘sparse’ chunk index 9. Maintaining such a ‘sparse’ chunk index reduces the size of the chunk index 9, a benefit of which will now be described.

Data processing apparatus may be used in compacting input data sets 1 for storage, encryption or transmission. For example the input data 1 may represent sets of back-up data from a first data storage medium, for storing on a second data storage medium. Data processing apparatus 3, as described above, compares a chunk identifier of an input data chunk 2 with the chunk identifiers stored in a chunk index 9. The step of comparison may require ready access to the data contained in the chunk index 9. In one embodiment, the chunk index 9 may be stored in random access memory (RAM). RAM allows quick, and random, access to the information contained therein. There may be a requirement, however, to reduce the RAM required for a data processing apparatus. By providing a sparse chunk index 9 to be stored in RAM, data processing apparatus requires less RAM than a processor without a sparse index.

Without providing a chunk index 9, data processing apparatus may compare an input data chunk 2 with each specimen data chunk 6 stored in the chunk store 4. Since the chunk store 4 may be very large, it may be difficult, or simply not possible, to store the entire contents of the chunk store 4 in RAM. The chunk store 4 may be stored in non-volatile memory, such as on disk. Reading data from the chunk store 4, therefore, will require a disk reading operation. This may be significantly slower than accessing data stored in RAM. Data processing apparatus 3 comprises a chunk index 9, which may reside in RAM, allowing faster access to the information contained therein. As a result, specimen data chunks 6 stored in the chunk store 4 which correspond to an input data chunk 2 may more easily be identified, without requiring constant direct access to the chunk store 4. There may, as described above, be a verification procedure. This operation will require access to a specimen data chunk 6 stored in the chunk store 4, on disk, but this may require only one disk seek of the chunk store 4 and the retrieval of a single specimen data chunk 6.

With embodiments of the present invention comprising a sparse chunk index 9, there may exist the case where a specimen data chunk 6 corresponding to an input data chunk 2 exists in the chunk store 4; but there is no entry relating to the specimen data chunk 6 in the chunk index 9. Thus, when comparing a chunk identifier of the input data chunk 2 with the entries in the chunk store 4, data processing apparatus 3 may indicate, initially, that there is no corresponding specimen data chunk 6; and store the input data chunk 2 as a specimen data chunk 6 in the chunk store 4 for a second time. Although this instance of storing the input data chunk 2 as a specimen data chunk 6 for a second time may be seen as an inefficient use of the chunk store 4, the benefits of such an embodiment is that the chunk index 9 is sparse, and thus uses less space in RAM. The benefits of requiring less RAM, and the decrease in the time taken to search through the sparse chunk index 9 may outweigh the disadvantages of the storage of an input data chunk 2 as a specimen data chunk 6 for the second time.

Nevertheless, because data processing apparatus 3 is operable to take advantage of the fact that input data streams may be partially similar to one another, the data processing apparatus 3 may identify a specimen data chunk 6 in the chunk store 4, even though there may be no entry for the specimen data chunk 6 in the chunk index 9, as described below.

For a given number of input data chunks 2, even though specimen data chunks 6 corresponding to each may already be stored in the chunk store 4, only one specimen data chunk 6 may have an entry in the chunk index 9. Data processing apparatus 3 is operable to identify a corresponding specimen data chunk 6 in the chunk index 9. From the specimen data chunk 6, the data processing apparatus 3 identifies at least one manifest segment in the manifest store that includes at least one reference to the specimen data chunk 6. In subsequently analysing the identified at least one manifest segment, the data processing apparatus 3 is operable to identify that there are specimen data chunks 6 in the chunk store 4 which correspond to more input data chunks 2 of the input data stream, even though those specimen data chunks 6 may not have entries in the chunk index 9.

Thus, such data processing apparatus may be operable to identify all the specimen data chunks 6 in the chunk store 4 corresponding to all the input data chunks 2, whilst only comprising a sparse index. There may be no duplicate entries in the chunk store 4. Data processing apparatus 3 with a sparse chunk index 9 may be just as efficient at compacting input data as data processing apparatus 3 with a full chunk index 9. By efficient is meant that the specimen data chunks 6 stored in the chunk store 4 are not duplicated, or at least not duplicated to a predetermined extent. Some duplication of specimen data chunks may be permitted.

Another embodiment of the data processing apparatus, with reference to the input data set 11 shown in FIG. 4, will now be described.

As described, the input data 11 may be processed into input data segments 13. Data processing apparatus is operable to identify that at least one input data chunk 12 of at least one of the input data segments 13 of the input data set 11 corresponds to a specimen data chunk 6 already stored in the chunk store 4. In doing so, at least that input data chunk 12 of the input data set 11 may be represented with a reference to the specimen data chunk 6 stored in the chunk store 4. If other input data chunks 12 of the input data set are found to correspond to specimen data chunks 6 already stored in the chunk store 4, the chunk store 4 may remain the same size but the data processing apparatus is operable to store a representation (i.e. the manifest) of the second input data set 11.

In one embodiment, with reference to FIG. 4, suppose that the first input data segment 13 is selected first for processing. The first input data segment 13 comprises input data chunks EFGHI. To determine that the chunk store 4 already contains specimen data chunks 6 corresponding to input data chunks EFGHI, without the present invention, may require a chunk-by-chunk comparison of the input data chunks with every specimen data chunk 6 in the chunk store 4.

In this embodiment of the present invention, there is provided a sparse chunk index 8, containing information on only some of the specimen data chunks 6 stored in the chunk store 4. The sparse chunk index 8 may have an entry only for specimen data chunks 6 having a predetermined characteristic. Alternatively, the sparsity of the chunk index 8 may be maintained at a predetermined level. For each entry in the chunk index 8 for a specimen data chunk 6, there is stored a chunk identifier of the specimen data chunk 6.

In the embodiment, a chunk identifier is generated for each input data chunk 12 of the selected input data segment 13. The chunk identifiers of the input data chunks 12 are compared with the chunk identifiers stored in the chunk index 8. Even though the chunk index 8 is a sparse chunk index 8, embodiments of the present invention are configured so that for a given input data segment, there is likely to be an entry in the chunk index 8 for at least one specimen data chunk 6 corresponding to an input data chunk 12 of the input data segment 13.

With further reference to FIG. 4, suppose that entries exist in the chunk index 8 for input data chunks E, G and I. Data processing apparatus will, accordingly, identify that there are entries in the index for specimen data chunks 6 corresponding to three input data chunks 12 of the first input data segment.

For each entry in the chunk index 8 for a particular specimen data chunk, there is stored a list of manifest segments 8 having at least one reference to that specimen data chunk 6. In the example shown in FIG. 3, there is currently only one previously compiled manifest stored. However, there may be a plurality of manifests (each comprising manifest segments) stored in the manifest store. A particular specimen data chunk 6 may be referenced by a plurality of manifest segments. Each of those said manifest segments, or at least a predetermined number of the said manifest segments, may be listed against the entry in the chunk index 8 for the specimen data chunk 6.

In this embodiment, it will seen that the first manifest segment 8 stored in the manifest store comprises a reference to specimen data chunk E, which corresponds to input data chunk E. Further, the second manifest segment 8 stored in the manifest store comprises references to both specimen data chunks G and I. In this embodiment, the data processing apparatus is operable to select first the manifest segment having references to the greatest number of specimen data chunks corresponding to input data chunks 12 of the input data segment 13 of the input data set 11. Accordingly, the data processing apparatus will select the second manifest segment 8, because it contains references to specimen data chunks 6 corresponding to two of the input data chunks of the input data segment 13 selected. There may be a high probability, therefore, that the second manifest segment 8 may contain references to specimen data chunks 6 corresponding to further input data chunks of the input data segment 13 selected.

Having selected the second manifest segment 8, the data processing apparatus is operable to compare a chunk identifier of each input data chunk 12 of the selected input data segment 13 with the chunk identifiers stored in the selected manifest segment 8. No comparison need be made with the chunk identifiers of the input data chunks which caused the manifest segment 8 to be selected. This is because it is already known that the manifest segment 8 contains references to specimen data chunks 6 corresponding to input data chunks G and I. Nevertheless, in an embodiment where the at least one manifest segment was identified using only a partial chunk identifier of an input data chunk matching a partial chunk identifier of an entry in the chunk index 8, it may be beneficial to compare the full chunk identifier of all input data chunks with the chunk identifiers of all specimen data chunks referenced in the identified manifest. This may then ensure that the identified at least one manifest truly does have at least on reference to a specimen data chunks 6 corresponding to an input data chunk of the selected input data segment.

Following a comparison step, the data processing apparatus will determine that the identified manifest segment 8 also contains references to specimen data chunks F and H. Accordingly, since there are already stored specimen data chunks corresponding to all of the input data chunks of the selected input data segment in the chunk store 4, a manifest may be part compiled for the selection input data segment using references to each of the relevant specimen data chunks 6.

In another example, if specimen data chunks 6 corresponding to all the input data chunks of a selected input data segment were not found, then subsequent manifest segments may be selected for analysis. The candidate manifest segments for subsequent analysis may have at least one reference to a specimen data chunk corresponding to at least one input data chunk of the input data segment being processed. The candidate manifest segments may be prioritised according to the number of references each contains to specimen data chunks 6 corresponding to input data chunks of the input data segments. It follows that a manifest segment having references to many specimen data chunks 6 that correspond to input data chunks of a given input data segment (existing in the chunk index 8) may be very similar to the input data segment. Such a manifest segment may therefore have references to specimen data chunks 6 corresponding to other input data chunks in the input data segment, for which there was not a corresponding entry in the chunk index 8 (due to its sparsity).

Having part compile a manifest for the input data set 11, there remains the second input data segment to be processed. The second input data segment comprises input data chunks J,K,P and O. Suppose, for this example that, of the specimen data chunks 6 referenced in the third manifest segment 8 shown in FIG. 3(b), there are entries in the chunk index 8 for specimen data chunks 6 L and M. As described above, the determination of which entries are made in the chunk index 8 may be at random, pseudo-random, or follow a different algorithm. For example, entries may only be made in the chunk index 8 for specimen data chunks 6 having a predetermined characteristic.

For the second input data segment 13, it will be determined by the data processing apparatus that the chunk index 8 does not contain an entry for a specimen data chunk 6 corresponding to any of the input data chunks J, K, P and Q. Accordingly, the data processing apparatus is not able to identify at least one manifest segment having at least one reference to a specimen data chunk corresponding to an input data chunk of the second input data segment.

It will be noted by the reader that specimen data chunks J and K are, in fact, referenced by the second and third manifest segments 8 stored in the manifest store. However, because neither of said manifest segments has a reference to a specimen data chunk 6 having an entry in the chunk index 8 which corresponds to an input data chunk of the second input data segment, the data processing apparatus will not identify the manifest segments.

Accordingly, the input data chunks J and K are added to the chunk store 4 as specimen data chunks 6. The manifest for the input data set 11 is populated with references to specimen data chunks J and K. Finally, since no references to specimen data chunks corresponding to input data chunks P and Q will be found (because they do not exist), the input data chunks P and Q are added to the chunk store 4 as specimen data chunks 6. The manifest for the input data set 11 is then completed with references to the specimen data chunks 6. The manifest may further be divided into manifest segments. The boundaries of the manifest segments may be identical to the boundaries of the input data segments they represent.

In another embodiment, if any specimen data chunks 6 referenced by a previously processed manifest segment were not found to correspond to an input data chunk of the preceding input segment processed, then those unmatched specimen data chunks 6 referenced by the previously processed manifest segment may be compared with the input data chunks of the next input data segment to be processed. This is beneficial where the boundary between contiguous input data segments happens to be located within a run of input data chunks which correspond entirely to a run of references to specimen data chunks 6 referenced by the previously processed manifest segment. In this embodiment, the unmatched specimen data chunks 6 of the previously processed manifest segment may be compared with all of the input data chunks of the next input data segment. In which case, it will be determined that input data chunk J already exists in the chunk store 4, because it is referenced at the end of the next input data segment.

Nevertheless, in this example, the third manifest segment will not be identified, since the second input data segment does not contain input data chunks L and M. A new specimen data chunk corresponding to input data chunk K may be added to the chunk store 4, despite the fact that it already exists. Although this may be seen as an inefficient use of the chunk store 4, such an arrangement has benefits in the reduction of processing operations. Further, by comparing only a segment of manifest and a segment of input data at a time, the comparison operation may be performed in RAM.

With the example shown in FIG. 4, it would have been possible to identify that specimen data chunk K exists in the chunk store 4, but a comparison of all input data chunks with all specimen data chunks 6 would have been required. With large manifests and input data sets, this may not be possible. At least, such a comparison would not have been able to be performed efficiently in RAM. Since in one embodiment the manifest store and chunk store 4 are stored on non-volatile storage, a plurality of disk reading operations would be required, which is inefficient. Data processing apparatus may load a segment of input data and a segment of manifest data into RAM at a time. Disk reading operations may conveniently be reduced as specimen data chunks 6 corresponding to input data chunks are quickly found.

In one embodiment, where an input data segment contains two input data chunks which are identical to one another and there is not found a specimen data chunk in the chunk store corresponding to the input data chunk, the data processing apparatus is operable only to store one input data chunk in the chunk store as a specimen data chunk. The manifest compiled for the input data segment will be compiled with two references to the single specimen data chunk in the chunk store. In one embodiment, the data processing apparatus is operable to perform this operation by comparing each input data chunk of an input data segment with one another. Such an operation may be carried out when an input data set is processed into input data segments comprising input data chunks. In one embodiment, the operation may be performed before the data processing apparatus seeks to identify at least one manifest segment having at least one reference to a specimen data chunk corresponding to an input data chunk of at least one of the input data segments.

In another embodiment, the operation may be performed after the data processing apparatus has attempted to identify at least one manifest segment having at least one reference to a specimen data chunk corresponding to an input data chunk of at least one of the input data segments.

In another embodiment, the operation may be performed after the data processing apparatus has attempted to identify, from the at least one identified manifest segment, at least one reference to a specimen data chunk corresponding to at least one further input data chunk of the input data segment being processed. In such an embodiment, the operation to find duplicate input data chunks within an input data segment may only then need to be performed on those input data chunks which have not been identified as corresponding to the specimen data chunks of the identified manifest segment or segments.

In one embodiment, there is provided data processing apparatus comprising: a chunk store containing specimen data chunks 6; and a manifest store containing at least one manifest that represents at least a part of a data set and is divided into manifest segments, each comprising at least one reference to at least one of said specimen data chunks 6. The processor is operable to: process input data into input data segments, each comprising one or more input data chunks; select an input data segment; and identify at least one of said manifest segments having at least one said reference to a said specimen data chunk corresponding to an input data chunk of the selected input data segment.

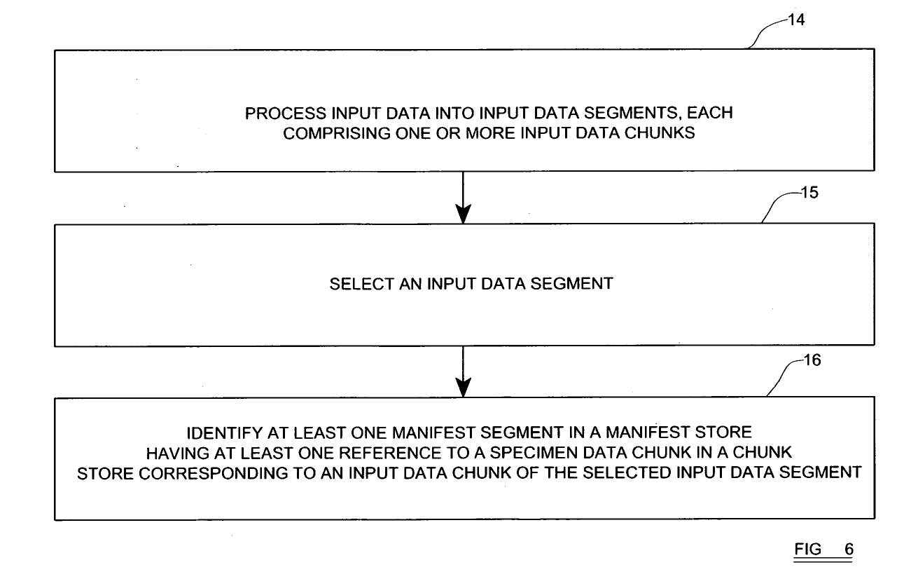

A method of processing data according to an embodiment, as shown in FIG. 6, uses:

a chunk store containing specimen data chunks, and

a manifest store containing at least one manifest that represents at least a part of a data set and is divided into manifest segments, each comprising at least one reference to at least one of said specimen data chunks. The method processing 14 input data into input data segments, each comprising one or more input data chunks; selecting 15 an input data segment; and identifying 16at least one of said manifest segments having at least one said reference to a said specimen data chunk corresponding to an input data chunk of the selected input data segment.

One embodiment of the present invention provides a method of compiling a manifest, representative of an input data set, the method comprising: processing the input data set into input data segments, each comprising one or more input data chunks; and identifying, in a manifest store, at least one manifest segment of at least one previously compiled and stored manifest, having a reference to at least one specimen data chunk, stored in a chunk store, corresponding to an input data chunk of at least one of the input data segments.

When the chunk store 4 and manifest store 5 of an embodiment of the present invention are first provided, there will be no specimen data chunks 6 stored in the chunk store 4 and no manifests stored in the manifest store. Both the chunk store 4 and manifest store 5 are then populated. Thus, when processing a first input data set 1, each of the input data chunks 2 divided from the input data set 1 will be added to the chunk store 4 as specimen data chunks 6. A manifest will be compiled for the input data set 1 and added to the manifest store 5. FIG. 3 illustrates an example of an at least partially populated processor according to an embodiment. It will be appreciated that as more and more input data sets 1 are processed, the chunk store 4 and manifest store 5 will contain more specimen data chunks 6 and manifests respectively. There may reach a point where the majority of input data chunks 2 of input data sets to be processed correspond to specimen data chunks 6 already stored in the chunk store 4. In such a case, a manifest 6 may be compiled for the input data set, without any new additions being made to the chunk store 4, further demonstrating the advantages of methods according to some embodiments.

The data processing apparatus 3 may form part of a data compaction, or de-duplication, management system. The data processing apparatus 3 may be integrated into a data storage system. A data processing apparatus 3 may be configured to operate ‘actively’, as data is sent to the data storage system for storage. Compaction may be performed in real time. Alternatively, data may be presented to the data processing apparatus 3 during ‘off peak’ periods. By off peak is meant periods where data may not be being presented to a data storage system for storage, and thus data processing apparatus 3 may process data already stored on the data storage system, to reduce any duplicated data already stored on the data storage system. Data processing apparatus may form part of a data housekeeping system of a data storage system.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. Data processing apparatus comprising:
a chunk store containing specimen data chunks,
a manifest store containing at least one manifest that represents at least a part of a data set and is divided into manifest segments, each comprising at least one reference to at least one of said specimen data chunks,
the data processing apparatus being operable to: process input data into input data segments, each comprising one or more input data chunks: and identify at least one of said manifest segments having at least one said reference to a said specimen data chunk corresponding to an input data chunk of at least one of the input data segments.

2. Data processing apparatus according to claim 1, wherein the data processing apparatus is operable to select a said input data segment and identify at least one of said manifest segments having at least one said reference to a said specimen data chunk corresponding to an input data chunk of the selected input data segment.

3. Data processing apparatus according to claim 1, operable to identify from the at least one identified manifest segment at least one said reference to a said specimen data chunk corresponding to at least one further input data chunk of at least one input data segment.

4. Data processing apparatus according to claim 1, wherein the data processing apparatus is operable to prioritise a plurality of identified manifest segments for at least one subsequent operation.

5. Data processing apparatus according to claim 4, wherein the plurality of identified manifest segments are prioritised according to the number of said references each has, to specimen data chunks corresponding to an input data chunk of at least one of the input data segments.

6. Data processing apparatus according to claim 5, wherein the plurality of identified manifest segments are prioritised in descending order of the number of said references each contains, to specimen data chunks corresponding to an input data chunk of at least one of the input data segments.

7. Data processing apparatus according to claim 1, operable to identify said manifest segments from different manifests stored in the manifest store.

8. Data processing apparatus according to claim 1, wherein the input data segments and said manifest segments are each of a predetermined size.

9. Data processing apparatus according to claim 1, wherein the input data segments and manifest segments are substantially identical in size.

10. Data processing apparatus according to claim 1, operable to compare each input data chunk of a given input data segment with the specimen data chunks referenced in the identified at least one manifest segments, to identify specimen data chunks corresponding to input data chunks of said input data segment.

11. Data processing apparatus according to claim 1, operable to process each input data segment in a predetermined order.

12. Data processing apparatus according to claim 1, comprising a chunk index containing information relating to said specimen data chunks.

13. Data processing apparatus according to claim 12, wherein the data processing apparatus is operable to identify at least one of said manifest segments using said information in the chunk index.

14. Data processing apparatus according to claim 1, wherein the manifest store contains a chunk identifier of said at least one specimen data chunk referenced by said at least one manifest.

15. Data processing apparatus according to claim 14, operable to generate a chunk identifier of each input data chunk for a said input data segment and compare the chunk identifier of each input data chunk with the chunk identifier contained in the manifest store.

16. A data processor comprising:
a chunk store containing specimen data chunks,
a manifest store containing at least one manifest that represents at least a part of a data set and is divided into manifest segments, each comprising at least one reference to at least one of said specimen data chunks,
the processor being operable to: process input data into input data segments, each comprising one or more input data chunks; select an input data segment; and
identify at least one of said manifest segments having at least one said reference to a said specimen data chunk corresponding to an input data chunk of the selected input data segment.

17. A method of processing data, using:
a chunk store containing specimen data chunks,
a manifest store containing at least one manifest that represents at least a part of a data set and is divided into manifest segments, each comprising at least one reference to at least one of said specimen data chunks,
the method comprising:
processing input data into input data segments, each comprising one or more input data chunks;
selecting an input data segment; and
identifying at least one of said manifest segments having at least one said reference to a said specimen data chunk corresponding to an input data chunk of the selected input data segment.

18. A method according to claim 17, comprising analysing said identified at least one manifest segment to identify at least one said reference to a said specimen data chunk corresponding to at least one further input data chunk of the selected input data segment.

19. A method according to claim 17, wherein the identified at least one manifest segments are prioritised according to the number of references each contains, to specimen data chunks corresponding to input data chunks of the selected input data segment.

20. A method of compiling a manifest, representative of an input data set, the method comprising:
processing the input data set into input data segments, each comprising one or more input data chunks.
identifying, in a manifest store, at least one manifest segment of at least one previously compiled and stored manifest, having a reference to at least one specimen data chunk, stored in a chunk store, corresponding to an input data chunk of at least one of the input data segments.
